(19) United States
(12) Patent Application Publication
(10) Pub. No.: US 2012/0185108 A1
(43) Pub. Date: Jul. 19, 2012

(54) Responsive Load Monitoring System and Method

(76) Inventors: Andrew Howe, Meopham (GB); Katie Bloor, London (GB); Joseph Warren, London (GB)

(21) Appl. No.: 13/387,168

(22) PCT Filed: Jul. 27, 2010
(86) PCT No.: PCT/NO2010/000291

§ 371 Date: Apr. 3, 2012

(30) Foreign Application Priority Data
Jul. 27, 2009 (GB) GB 0913038.6
Aug. 24, 2009 (GB) GB 0914733.1
Nov. 4, 2009 (GB) GB 0919378.0

(51) Int. Cl. G05F 5/00

(52) U.S. Cl. 700/295

(57) ABSTRACT

A system employs a method of determining a level of potential responsive-load electrical power network service susceptible to being provided by one or more power consuming devices (100). The method includes: (a) determining operating characteristics of power consuming devices; (b) developing a parameterized numerical model of operation of the power consuming devices based upon the determined operating characteristics; (c) developing an operating regime using the numerical model and a set of operating rules for the devices for providing responsive-load electrical power network service; (d) applying the operating regime to each of the devices; and (e) monitoring operating characteristics of the power consuming devices (100) after installation for verifying their responsive-load electrical power network service. Optionally, the devices are operable to function autonomously to provide their responsive-load electrical power network service. Optionally, the parameterized numerical model of operation describes a fullest extent to which the power consuming devices are capable of providing responsive-load electrical power network service.

### FIELD OF THE INVENTION

The present invention relates to responsive load monitoring systems, for monitoring operation of responsive loads coupled to electrical power networks for providing dynamic demand response thereto. Moreover, the present invention also concerns methods of monitoring dynamic-demand response of power-consuming devices for use in providing dynamic demand response to electrical power networks. Furthermore, the present invention relates to software products recorded on machine-readable data storage media, the software products being executable on computing, hardware for implementing aforesaid methods.

### BACKGROUND OF THE INVENTION

Electrical systems include power generators, power consuming devices and electrical power networks coupling the power generators to the power consuming devices. Electrical power networks are often referred to as being “electricity grids”. In operation, power output provided from the power generators can temporally fluctuate, and power demand exhibited by the power consuming devices can also temporally vary. In consequence, alternating frequency and alternating voltage magnitude are parameters in the electrical power networks which are susceptible to fluctuation. Such fluctuation can result in problems for consumers who are presented with potentially unpredictable electrical mains supply frequencies and/or mains potentials. Moreover, operators of the electrical power networks also have an obligation to ensure that mains supply frequency excursions from a nominal centre frequency are kept within agreed limits, for example in a range of 49.5 Hz to 50.5 Hz with 50.0 Hz as a nominal centre frequency. Power consuming devices can potentially malfunction with disastrous consequences when provided with a mains electrical supply which grossly deviates from its nominal potential and frequency. Such control becomes more difficult to achieve when the power generators employ wind turbine energy technology and/or solar radiation (photovoltaic) renewable energy technology which are prone to wide fluctuations depending upon changing weather conditions, for example as a function of varying cloud cover and/or wind gusts. An additional complication arising is that certain types of power generators, for example coal burning power stations and nuclear plant, are not able to adjust their output power rapidly without dumping excess energy as waste heat into the environment which is an unattractive commercial option.

Whereas it has been known for many years to control the electrical power networks selectively for assisting to match a magnitude of supply of electricity from the power generators to a magnitude of demand presented by the power consuming devices under normal conditions, such control of the electrical power networks is often not able to cope with major mismatches of supply and demand for electrical power; such sudden gross mismatch can occur as a result of accident and/or extreme weather conditions when an unexpected number of air conditioning units are brought substantially simultaneously into operation. When control of electrical power networks is not possible to maintain, blackouts can occur as occasionally experienced in the USA and frequently encountered in third world countries. In consequence, it has been proposed that the electrical power networks should be implemented as “smart grids”, for example as described in a published United States patent application US2009/0200988A1 “Power Aggregation System for Distributed Electrical Resources” with V2Green Inc., Seattle, USA named as proprietor. The patent application describes a method of establishing a communication connection with each of a multiple of electrical resources connected to an electrical power network, and receiving an energy generation signal from the electrical power network operator for controlling a number of the electrical resources being charged by the electrical power network as a function of the energy generation signal. Smart devices coupled to an electrical power network are responsive to adjust their power consumption in response to aggregate loading on the electrical power network so as to assist to stabilize operation of the electrical power network. Such responsiveness not only renders the electrical power network easier to control, but also enables the electrical power network to receive power from diverse power suppliers subject to more fluctuations of output, for example from arrays of small Darrieus wind turbines and/or solar cells (photovoltaic panels distributed at various domestic locations and/or coastal wave energy generating facilities).

A problem arising in practice is how to adapt and monitor performance of different types of electrical power consuming devices when assisting to provide smart regulation of electrical power networks, namely to provide a “dynamic response” service. Such adaptation and monitoring is beneficial when attempting to stabilize operation of the electrical power networks, as well as monitoring whether or not smart regulation is being provided by such devices. Whereas electricity power networks can be simulated on computing hardware based upon historical measured electrical power network characteristics, such simulation does not reliably provide a true indication of smart electrical load performance providing dynamic response to electrical power networks on account of the enormous complexity of contemporary electrical power networks.

Commercial electrical power network_{;} operators provide a service conveying power from power generators to power consuming devices. It is contemporary practice for these power network operators to pay power regulating companies to provide electricity network stabilizing services, namely providing “dynamic response” services. An example of such “dynamic response” service is provided by a pumped-water energy storage facility at Dinorwic in Wales. At this example storage facility, excess energy provided by power generators in periods of low electricity demand is used to pump water from a lower reservoir to a higher reservoir. In periods of high electricity demand, the pumped water is allowed to flow from the upper reservoir via a conventional hydroelectric generating turbine to the lower reservoir to generate rapidly additional power to assist to match sudden additional electricity demand to the electricity power network. An advantage with this facility is that water flowing from the upper reservoir to the lower reservoir can be adjusted very rapidly for providing corresponding rapidly adjustable supply of electrical power. However, a problem with this facility is that energy used to pump water from the lower reservoir to the upper reservoir is only partially recoverable when the water subsequently flows from the upper reservoir to the lower reservoir. In other words, although this pumped-water storage facility provides useful dynamic power stabilization response, it is relatively energy inefficient with associated potential penalty of additional release of carbon dioxide into the atmosphere corresponding to such inefficiency.

In a published U.S. Pat. No. 4,819,180, there is described a method and system for regulating power delivered to different commercial and residential users in which each user has variable demands for power consumption, there being a power source from which power is transmitted by a utility to each user and a utility control signal which is transmitted from the utility to each use in order to modify the power consumed by each user. The method includes measuring the power consumption of each user over a selected real time interval, and modifying the power consumption by each user by an amount directly related to the power consumption measurement of each user over that time interval. The method does not involve generating any parameterized model of power consumption characteristics of the commercial or residential users.

### SUMMARY OF THE INVENTION

It is appreciated that, rather than using a pumped-water storage facility such as Dinorwic to provide electrical power network stabilization response, it is far more preferable that the power consuming devices themselves are operable to provide dynamic load response; this is far more energy effective than using pumped-water storage facilities or similar types of dedicated energy storage facility and can potentially provide a much faster demand response. Although a stabilizing capacity available from a pumped-water storage facility can be relatively easily monitored as a function of water level in upper and lower reservoirs thereof, it is difficulty to estimate a magnitude of responsive load capacity available when such responsive load capacity is distributed widely around an electrical’ power network, for example when stabilizing capacity is implemented as a multitude of domestic appliances. Estimates of responsive load capacity can potentially be made based upon a number of sales of such domestic appliances, but this is not a guarantee that such responsive capacity is actually available at any given instance of time when responsive load stabilization is required, for example to avoid occurrence of a blackout with potentially disastrous consequences. There thus arises an issue of verifying “demand response” service being operatively provided by power consuming devices, for example implemented as domestic appliances, to electrical power network operators; such verification is potentially needed for both financial and carbon accounting purposes as well as for ensuring that sufficient “demand response” service is available for adequately stabilizing electrical power networks.

The present invention seeks to provide a method of adapting and/or verifying operation of one or more devices developed to provide an improved responsive load service.

The present invention seeks to provide a method of adapting one or more devices to provide an improved responsive load service.

According to a first aspect of the invention, there is provided a method as claimed in appended claim 1: there is provided a method of determining a level of potential responsive-load electrical power network service susceptible to being provided by one or more power consuming devices, wherein the method includes:
(a) determining operating characteristics of one or more power consuming devices;
(b) developing a parameterized numerical model of operation of the one or more power consuming devices based upon the determined operating characteristics; and
(c) developing an operating regime using the numerical model and a set of operating rules for the one or more devices for providing responsive-load electrical power network service.

The invention is of advantage in that the one or more devices are capable of being adapted by way of parameterized models to provide an improved autonomous responsive load service for assisting to stabilize operation of an electrical power network and/or to reduce its operating costs.

Such reduction in operating costs optionally involve, for example, reduction in carbon dioxide generation associated with rapid-response gas fired electricity generating plant employed to provide electrical power network stabilizing services.

Optionally, the one or more devices are operably functional to provide the responsive-load electrical power network service in an autonomous manner. “Autonomous” is to be construed to mean that control of the one or more power consuming devices is controlled locally to the one or more devices based upon conditions sensed at the one or more devices in contradistinction to an arrangement where control signals are sent to the devices from a remote location, for example control signals issued from a management centre for the electrical supply network or from a management centre for electrical supply generators.

Optionally, the method includes:
(d) applying the operating regime to the one or more devices for providing the responsive-load electrical power network service.

Optionally, the method is implemented such that the parameterized numerical model of operation describes a fullest extent to which the one or more power consuming devices are capable of providing the responsive-load electrical power network service. The phrase “a fullest extent” is to be understood to mean a potential full capacity, namely an enhanced capacity by using a more accurate and more optimal capacity model based upon parameters describing processes occurring within the power consuming device. Thus, the capacity model is a parameterized numerical model of operation which describes a more realistic, accurate and therefore more optimal model defining a fuller extent to which the one or more power consuming devices are capable of providing a responsive-load electrical power “ network service.

Optionally, the method includes monitoring operating characteristics of the one or more power consuming devices after installation for verifying their responsive-load electrical power network service. More optionally, the method is implemented such that monitoring of the one or more devices is performed remotely via one or more interface (for example proprietary “ReadM”) devices.

Optionally, the method is implemented such that the determination of the operating characteristics includes determining at least one of parameters α, β, η and T, wherein the parameters α and β describe an expected proportion of time in which the one or more devices are able to switch ON/OFF, the parameter η describes a working ratio of the one or more devices, and the parameter T describes operating cycle times of the one or more devices.

Optionally, the method includes at least one of:
(a) communicating an availability of the one or more power consuming devices to provide load response service;
(b) communicating an amount of stored energy in the one or more power consuming devices;
(c) communicating an amount of energy storage capacity remaining in the one or more power consuming devices and/or the amount actually consumed;
(d) communicating an indication of a power load and/or aggregate load response the one or more power consuming devices are capable of providing and/or are actually providing to the electrical power network; and
(e) communicating an indication of the absolute power load the one or more power consuming devices are actually consuming in operation from the electrical power network.

Optionally, the method is adapted for enabling at least one the following devices to provide a responsive-load electrical power network service:
(a) a refrigerator;
(b) a hot water system;
(c) an air conditioning system;
(d) a charger for an electric and/or plug-in hybrid vehicle;
(e) a washing machine;
(f) a dishwasher;
(g) an electric oven;
(h) an electric heating, ventilation and/or cooling system for a building.

Optionally, the method further includes at least one of:
(a) performing a thermal model calibration at nominal electrical power network mains frequency f₀ on the one or more devices;
(b) performing a frequency test to determine how rapidly one or more of the one or more devices respond to a frequency perturbation applied to the one or more devices;
(c) performing a test to determine a nominal frequency f₀ adopted by the one or more devices when in operation;
(d) performing a test to determine upper and lower frequency limits for mains supply provided to the one or more devices to check for conformity with test specifications;
(e) determining trigger frequencies for the one or more devices for the nominal centre frequency f₀ (tarF test); and
(f) determining a staggered response and/or aggregate response for one or more devices by measurement.

The present invention also seeks to provide a responsive load monitoring system which is capable of monitoring network stabilization response presented in operation by one or more smart power consuming devices coupled to one or more electrical power networks.

According to a second aspect of the present invention, there is provided a system as claimed in appended claim 11: there is provided a system for monitoring and determining a level of responsive-load electrical power network service provided by one or more power consuming devices coupled via an electrical power network to one or more power generators, the responsive-load service including at least one of: frequency control, load control, characterized in that the system includes a communication arrangement for communicating information indicative of the responsive-load service being provided to a data processing arrangement for controlling and/or monitoring operation of the electrical power network.

The invention is of advantage in that it is capable of providing an enhanced degree of electrical power network monitoring, for example for achieving improved stability and/or efficiency of operation of the network.

Optionally, with respect to the first aspect of the invention, the system is adapted to measure a value, availability, duration, magnitude and delivery of a responsive-load regulating service provided by a population of power consuming devices.

According to a third aspect of the invention, there is provided a method of monitoring and determining a level of responsive-load stabilization service provided by one or more power consuming devices coupled via an electrical power network to one or more power generators, the stabilization service including at least one of: frequency control, load control, characterized in that the method includes:

(a) communicating using a communication arrangement information indicative of the stabilization service being provided to a data processing arrangement for controlling and/or monitoring operation of the electrical power network.

According to a fourth aspect of the invention, there is provided a responsive-load electrical power network control system including a distributed population of one or more responsive-load power consuming devices coupled via an electrical power network to one or more power generators, the system being operable to utilize information of dynamic load to schedule a configuration of the one or more power generators.

According to a fifth aspect of the invention, there is provided an interface device (for example, a proprietary “ReadM” device) for use with one or more responsive-load power consuming devices coupled via an electrical power network to one or more power generators of a system pursuant to the second aspect of the invention, the interface device (for example a “ReadM” device) being adapted for communicating operation of the one or more responsive-load power consuming devices to a data processing arrangement for enabling the data processing arrangement to monitor and/or control operation of the electrical power network.

According to a sixth aspect of the invention, there is provided an aggregation machine for use with the system pursuant to the second aspect of the invention, the aggregation machine being operable in real-time to add together load states of the one or more power consuming devices to provide an aggregate indication of load states.

According to a seventh aspect of the invention, there is provided a method of estimating an availability of a service level of a population of responsive-load power consuming devices coupled in operation via an electrical power network to one or more power generators, the method including:

(a) measuring an availability of a subset of the population for providing responsive-load service at a time of manufacturing the one or more responsive-load power-consuming devices or during commissioning of the one or more responsive-load power-consuming devices or during servicing of the one or more responsive-load power-consuming devices.

According to an eighth aspect of the invention, there is provided a method of estimating frequency response provision and/or carbon dioxide emission saving of a population of power-consuming devices by monitoring:
(a) a percentage of time available in which the one or more power-consuming devices are able to provide responsive-load service;
(b) energy or application state characteristics of the one or more devices; and
(c) an electrical consumption of the one or more power-consuming devices over one or more associated cycles of application states.

According to a ninth aspect of the invention, there is provided a power-consuming device for providing responsive-load to an electrical power network arranged to couple one or more power generators to one or more power consuming devices, the device being operable to track a period of time over which it is available to provide a responsive-load service, a period of time that the device has provided responsive-load service, and to communicate information regarding the period of time as output from the device.

According to a tenth aspect of the invention, there is provided a system including a population of one or more power consuming devices coupled via an electrical power network to one or more power generators, characterized in that the population of one or more power consuming devices are operable to continuously signal and/or record their availability to provide a responsive-load service, such service pertaining to whether the one or more devices are ON, OFF or operating at an intermediate level, and whether or not, and the extent to which, they are available to provide the service.

According to an eleventh aspect of the invention, there is provided a method of using BMS alarms and/or other messages in a system pursuant to the ninth aspect of the invention for providing a compressed stream indicative of a changing availability and/or ON/OFF and/or operating states of one or more power consuming devices from which the availability and provision of a responsive-load service can be determined.

Optionally, when implementing the method, the BMS alarms and/or other messages are encrypted for authenticating that a service has been provided by the one or more power-consuming devices. More optionally, such encryption is achieved using private-public key encryption.

Optionally, in relation to the second aspect of the invention, the system is operable to determine an amount of service provided during an event when the service is invoked, wherein provision of the service is verified by comparing an actual electrical consumption of a sample of devices with an estimated consumption of those devices and/or an estimated consumption of devices in a population.

According to a twelfth aspect of the invention, there is provided a system operable to record in one or more devices:
(i) a cumulative measure of a quantity of dynamic-demand/frequency-response stabilization provided by one or more power-consuming devices;
(ii) a time period over which the service is provided; and/or
(iii) information from the one or more devices via use of a series of key strokes entered in a data entry device.

According to a thirteenth aspect of the invention, there is provided a verification device implemented by way of one or more of: a frequency inverter, a pattern generating device, an EGS signal generating device, said communication device for allowing verification of a quantity of dynamic demand response/frequency response, said verification being achieved by repetitively sending event signals to the verification device.

According to a fourteenth aspect of the invention, there is provided a method of using a frequency inverter device pursuant to the thirteenth aspect of the invention, wherein the method involves generating results using the device, and analysing the results to confirm an amount responsive-load service provided.

According to a fifteenth aspect of the invention, there is provided an in-line metering device operable to record power consumed by a power-consuming device and a variable of an electrical power network operable to supply power to the device for measuring an amount of a responsive-demand service provided by the device to the electrical power network.

According to a sixteenth aspect of the invention, there is provided an in-line metering device operable to communicate with a power-consuming appliance for measuring a period of time during which the appliance is available to provide a service of frequency response or dynamic demand to an electrical power network providing power to the appliance.

According to a seventeenth aspect of the invention, there is provided a method of predicting a quality of response provided by a device for providing an availability-based service, the prediction being based upon a simulation model incorporating energy state simulations for the device.

According to an eighteenth aspect of the invention, there is provided a software product recorded on a machine-readable medium, the software product being executable on computing hardware for implementing a method pursuant to the seventeenth aspect of the invention.

According to a nineteenth aspect of the invention, there is provided a test mode method of a system pursuant to the second aspect of the invention, the test mode method relating to providing frequency stabilization response to the system via one or more power-consuming devices coupled to the system. Optionally, the test mode is devoid of a frequency inverter device pursuant to the twelfth aspect of the invention.

It will be appreciated that features of the invention are susceptible to being combined in any combination without departing from the scope of the invention as defined by the accompanying claims.

### DESCRIPTION OF THE DIAGRAMS

Embodiments of the present invention will now be described, by way of example only, with reference to the following diagrams wherein:

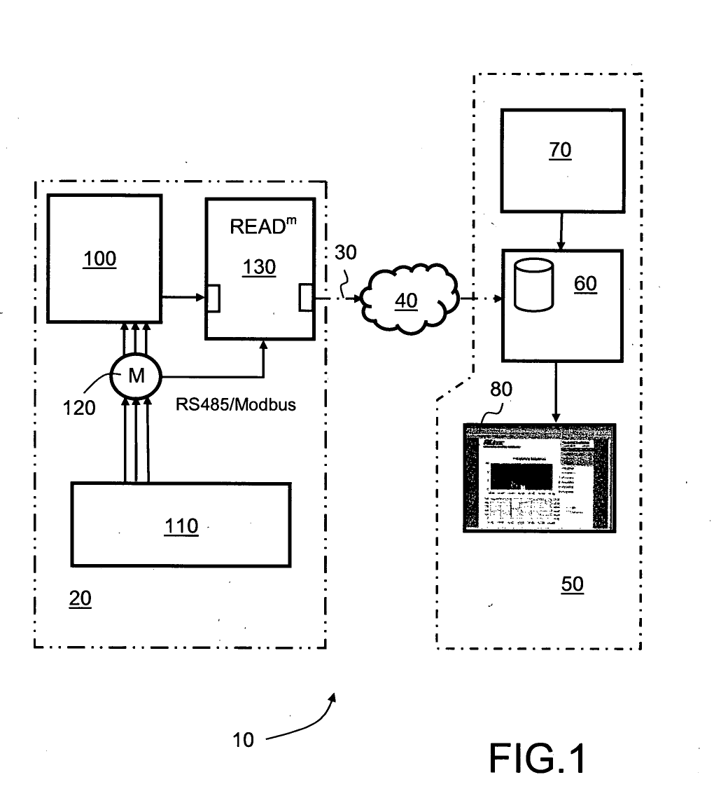

FIG. 1 is an illustration of a system pursuant to the present invention;

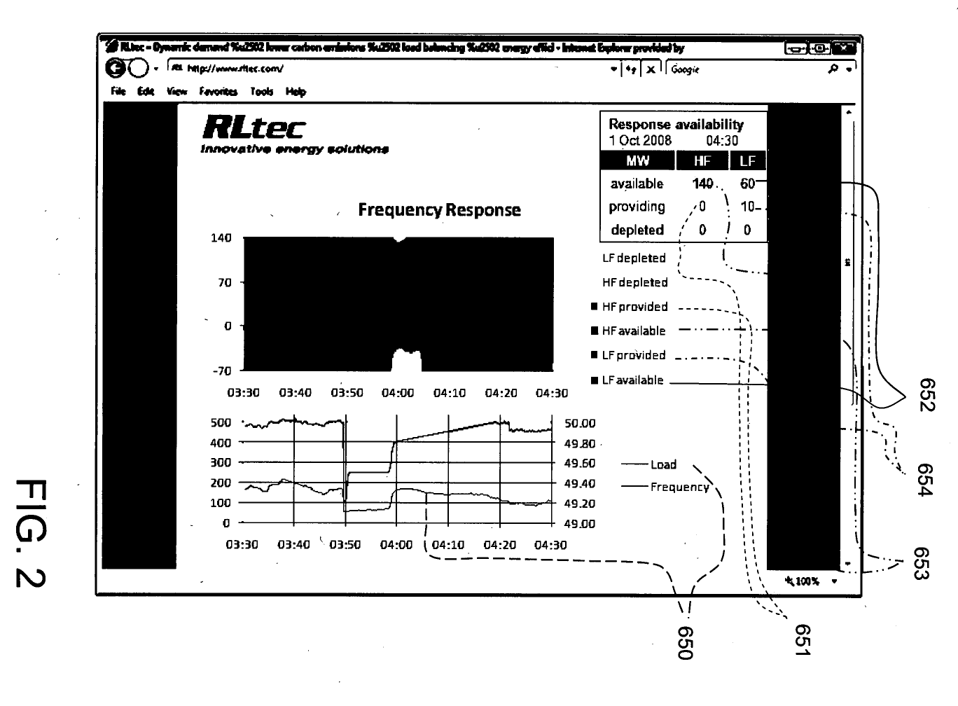

FIG. 2 is an illustration of a presentation of responsive load provided, the presentation being shown on a display of a control arrangement of the system of FIG. 1;

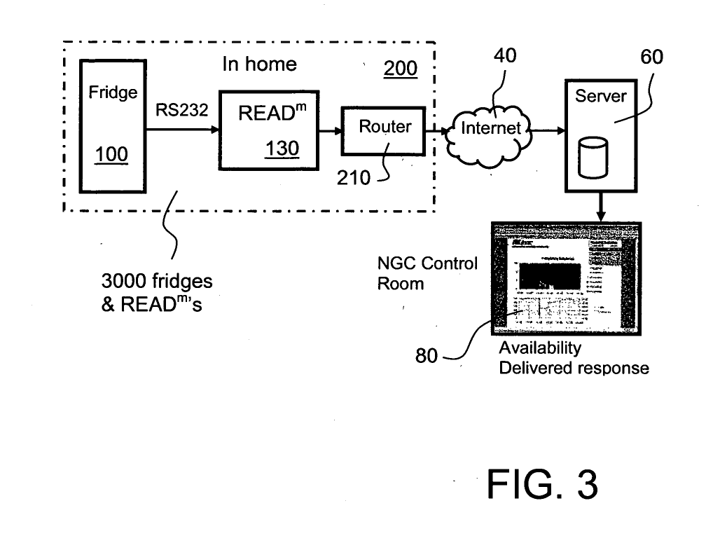

FIG. 3 is an illustration of the system of FIG. 1 implemented in respect of a refrigerator as a power-consuming device capable of provide responsive load service;

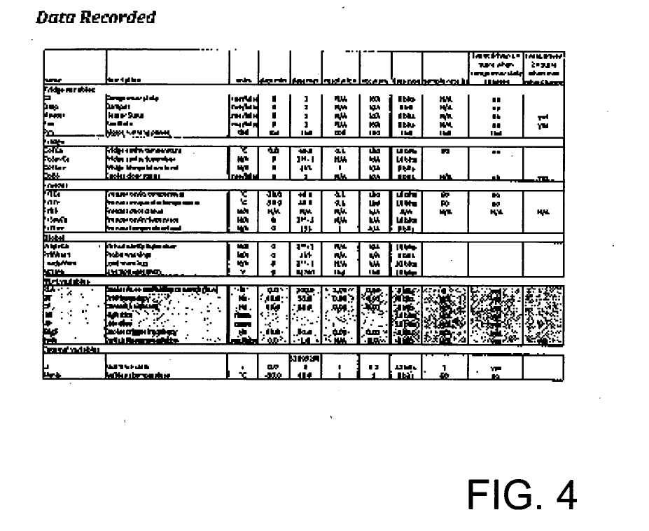

FIG. 4 is an illustration of a table of response load performance data generated by the system in FIG. 1;

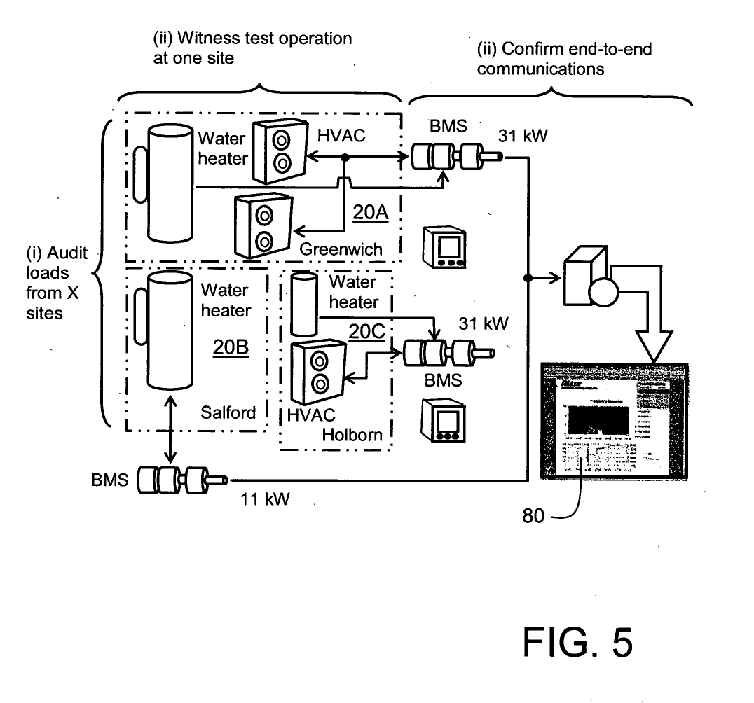

FIG. 5 is an illustration of the system of FIG. 1 adapted to monitor and/or control a plurality of power-consuming devices which are spatially distributed;

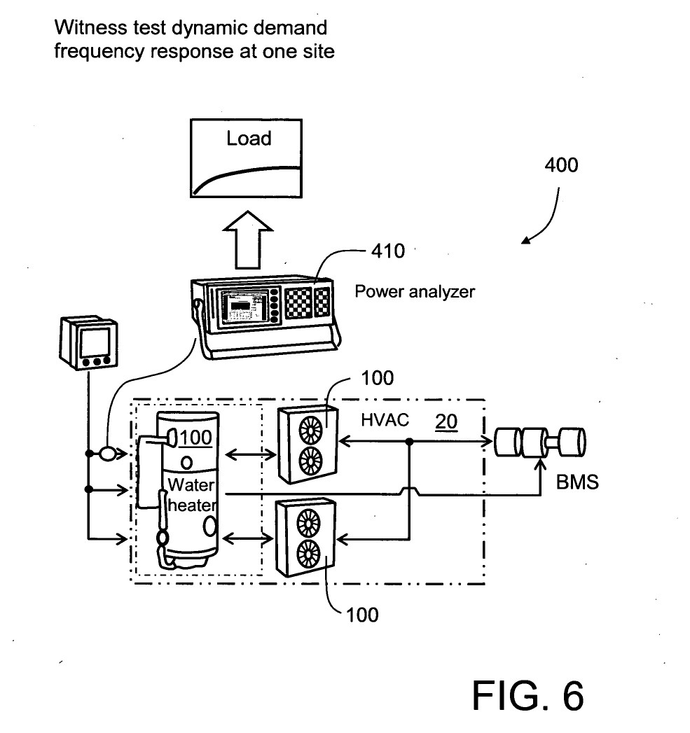

FIG. 6 is an illustration of a use of the system of FIG. 1 implemented for witnessing and/or verifying dynamic demand frequency response;

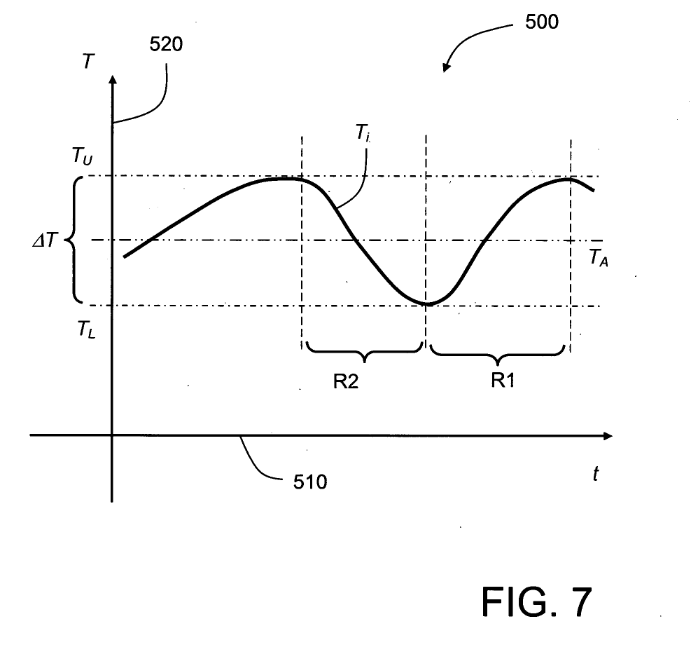

FIG. 7 is an illustration of a temporal response with respect to internal chamber temperature of a refrigerator implemented to embody the present invention;

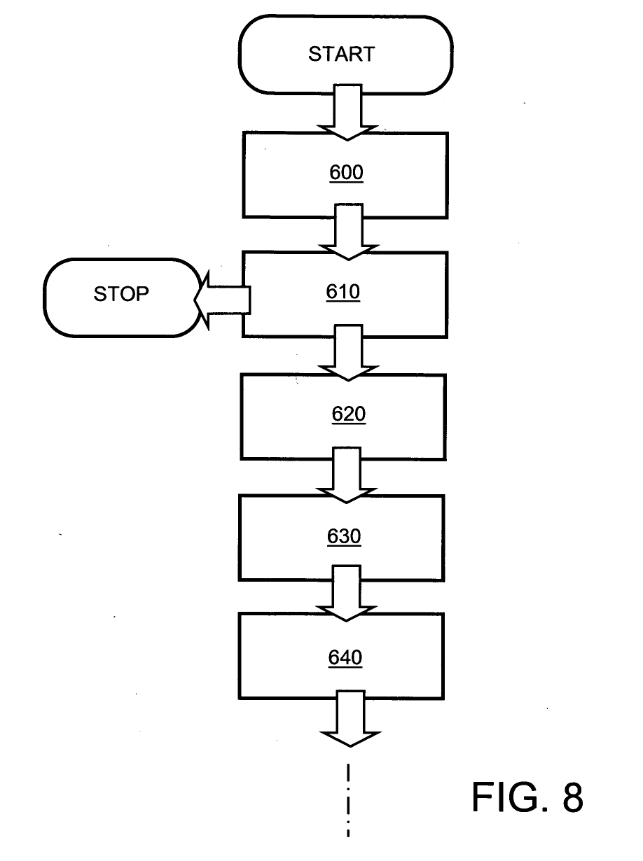

FIG. 8 is a flow chart of a method of testing an appliance pursuant to the present invention for purpose of characterizing dynamic response susceptible to being provided from the device;

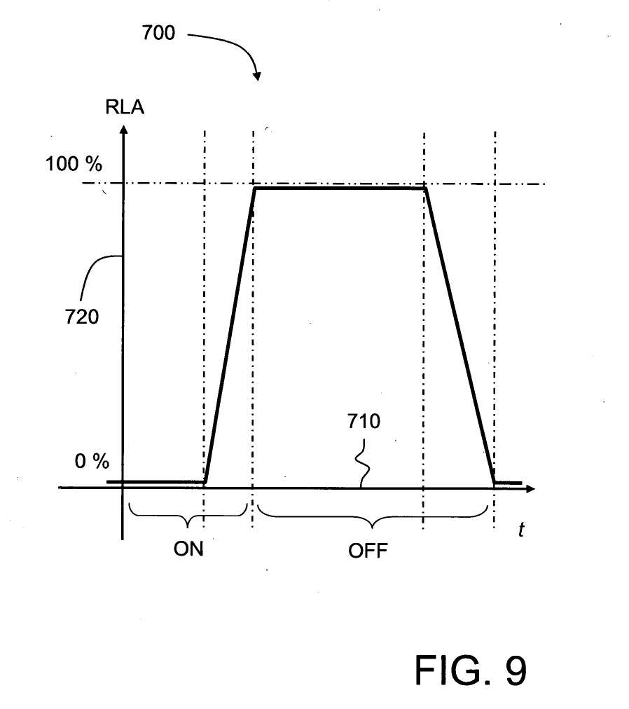

FIG. 9 is an illustration of RLtec availability, namely responsive load availability (RLA), of the appliance of FIG. 8; and

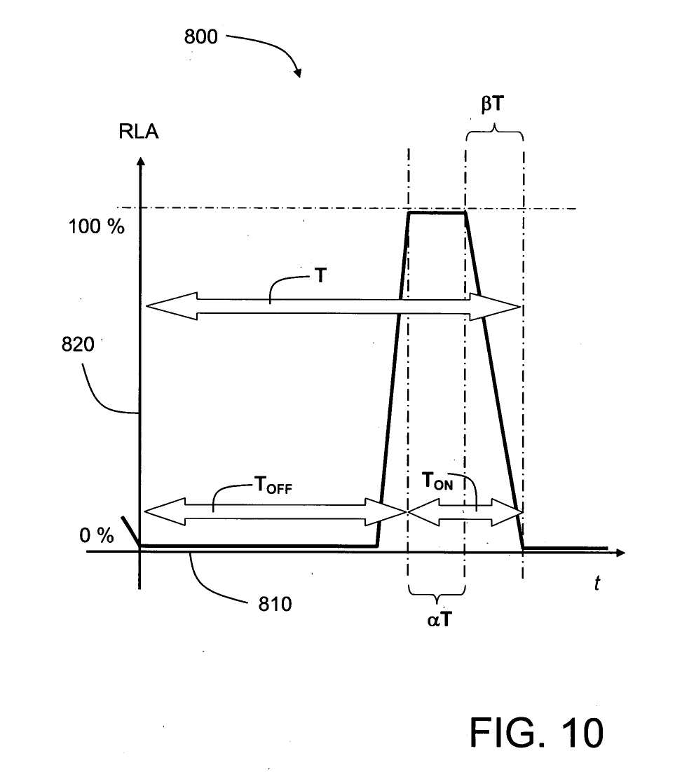

FIG. 10 is an illustration of parameters α, β and T in respect of the present invention.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS OF THE INVENTION

In overview, the present invention is concerned with a system for monitoring and determining a level of responsive load service provided by a distributed resource of one or more power consuming devices in respect of one or more electrical power generators which are mutually electrically coupled together via an electrical power network to the one or more devices; the electrical, power network, namely electrical grid, is operable to enable electrical power to be provided from the electrical generators to the one or more power consuming devices. A level of responsive load service includes, for example, a degree to which the one or more electrical power consuming devices are able to match their electrical load presented to the electrical power network in response to an ability of the electrical power generators to supply electrical power to the electrical power network In practice, the level of responsive load service provided will be imperfect, in which case it is highly desirable to be able to determine a degree of imperfection arising in practice under various dynamic conditions. The present invention is distinguished in that the one or more power consuming devices are subject to modelling for representing their operating characteristics in a parameterized manner, thereby representing a potential full capacity of the devices to provide responsive load service; such benefit is to be compared with conventional known approaches which merely measure characteristics of the devices over a limited period of time over a limited part of a responsive range of the one or more power consuming devices; thereby resulting in suboptimal performance in conventional response load devices. Such modelling and parameterization pursuant to the present invention enables better autonomous control of the electrical supply network in operation to be achieved.

Moreover, the present invention is concerned with methods of monitoring and determining a level of responsive load service provided in a system comprising a distributed resource of autonomous power consuming devices and electrical power generators which are mutually electrically coupled together via an electrical power network, wherein the electrical power network is operable to enable electrical power to be provided from the electrical generators to the electrical loads.

The system for monitoring and determining the level of responsive load service is beneficially employed such that information gained from a population of autonomous electrical power consuming devices coupled to an electrical power network is used to schedule a configuration of one or more electrical generators coupled to supply electrical power to the electrical power network. The electrical devices are each beneficially provided with computer-implemented interface units, for example proprietary “ReadM” units, or functionally similar modules which are operable to receive data from their respective electrical power consuming devices and communicate electrical consumption and/or electrical regulation characteristics provided by the devices, and to convey this data to a remote database, for example via Internet communication, wireless communication, optical fibre communication and/or any other manner of communicating data from one location to another.

Beneficially, computer-implemented systems, for example embodied in a proprietary “ReadM” unit, or distributed over a number of different devices or units, are operable to provide data indicative regarding at least one of:
(i) an amount of response load regulation that the power consuming device is capable of providing and/or an availability (RLA) of the power consuming device to provide a responsive load characteristic for an electrical power network;
(ii) an amount of stored energy capacity that has been extracted, namely “used up” from the power consuming device which is capable of being used for providing demand response to the electrical power network;
(iii) an amount of stored energy remaining in the power consuming device, namely “remaining capacity”, which is capable of being used for providing demand response to the electrical power network; and
(iv) an indication of time associated with data provided in respect of one or more of properties (i) to (iii).

For example, the data is indicative of properties (i) and (ii) only, or properties (ii) and (iii) only, or a combination of all three properties (i), (ii) and (iii). Optionally property (i) is provided by the interface units sending an identity of its associated device, and a subsequent mapping, for example via a look-up table, is utilized for determining from the identity of the device a corresponding power consumption rating. In a case of the device being a refrigerator, the property (i) is determined by a capacity of a compressor or Peltier element utilized in the refrigerator. Alternatively, in a case of the device being a charger for a plug-in hybrid vehicle, the property (i) is a measure of a charging capacity of the charger. Yet alternatively, when the device is an electrical heater for a hot water tank, the property (i) is a Wattage rating of the heater. Conversion of one of more of the properties (i) to (iii) is implemented at one or more remote servers to which the interface units are operable to communicate. Yet alternatively, when the devices are one or more variable speed fans, the property (i) is ascertained by calculation or lookup using the current speed of the one or more fans, or control set-points of the one or more fans. Properties (i) to (iii) can, for example, be expressed in a manner of “RLtec availability”, also referred to responsive load availability (RLA), namely pertinent for devices with a discrete ON/OFF type power switching characteristic when in operation.

Beneficially, the remote database is implemented as one or more remote servers. Beneficially, an aggregating machine, for example implemented using computing hardware coupled to the database, is operable to aggregate data from a diverse range of devices to generate aggregate data representative of load state changes exhibited by the devices when in operation coupled to their electrical power network. Beneficially, sampling data from a portion of a population of devices is employed to predict a responsive load characteristic for the entire population, thereby reducing an amount of substantially duplicate data which would have to be collected in a situation where data were to be received from all devices in the population.

The system is thus capable of providing a measurement of value, availability, duration, magnitude and/or delivery of a responsive load service, for example a dynamic demand response service provided for stabilizing a population of the devices when in operation. By “dynamic demand response” and “responsive load service”, it is meant changing electrical load represented by the devices in response to overall load on an associated electrical power network. By “frequency stabilization”, it is meant changing electrical load represented by the devices in response to overall load on an associated electrical power network in order to assist to stabilize an operating frequency of the network.

The system for monitoring and determining pursuant to the present invention is also capable of monitoring electricity grid response provided by a small population of devices at time of manufacture and/or during commissioning and/or during servicing. Such functionality of the system enables the system to be used by an electrical device manufacturer, for example by an electrical appliance manufacturer, during product development and/or when upgrading existing electrical devices to provide electrical grid stabilization response. The system is especially relevant, for example, to manufacturers of domestic appliances, wherein the domestic appliances additionally include responsive load functionality. Companies such as RLtec Ltd. are operable to collaborate with such manufacturers and undertake contractual obligations for proving responsive load service to electrical power network operators in return for payment from the network operators. These companies such as RLtec Ltd. need to provide proof, for example on a regular ongoing basis, that the manufactured devices provided from the manufacturer are continuing to provide responsive load service, namely autonomous responsive load service.

The aforementioned system pursuant to the present invention is, for example, capable of being used to determine a carbon dioxide emission saving of a population of power consuming devices, taking into account a percentage of time available in which the population of devices is available for providing demand stabilization to an electricity grid to which they are coupled in operation. For example, information regarding such carbon emission saving can be used for purchasing carbon emission credits, for example for providing a mechanism by which customers are given financial credits, namely financially compensated, in response to their devices or appliances functioning to provide electricity grid stabilization having a consequence that electrical generators emit less carbon dioxide. As a further example, information regarding such carbon emission saving can be used for purchasing carbon emission credits, for example for providing a mechanism by which manufacturers of appliances are given financial credits, namely financially compensated, in response to their devices or appliances functioning to provide electricity grid stabilization having a consequence that electrical generators emit less carbon dioxide. When such payments of carbon credits are dependent on providing evidence of carbon savings having been provided by responsive load devices, it is necessary to employ a system and associated method of monitoring a population of autonomous responsive load devices. The present invention is aimed at addressing this need for such evidence.

The system beneficially also concerns a device which is operable temporally to monitor, namely to track temporally, how long it has been in operation to provide a service to assist to stabilize an electrical power network to which it is coupled and to communicate such information from the device, for example via Internet and/or wireless to a server or other similar type of database, for example collating evidence of responsive load service having been provided over a given period of time. For example, the device can record its electrical power network responsive load response as a function of time over a period of time and then subsequently communicate data describing the demand response performance over the period to a remote server or database; such a manner of communication reduces a volume of communication traffic to be sent which is relevant when many millions of such devices are in use reporting dynamically to the server or ‘database, especially when the devices are operable to compress their response data prior to communicating such data to the server or other type of database. Such immediate dynamic response is desirable to avoid temporal delays which would otherwise provide a delay which would render it difficult to apply feedback control for the control an electricity grid accurately, for example for avoid oscillatory power demand behaviour when attempting to control the electricity grid coupled to smart demand-responsive power-consuming devices.

Aggregation of data from a population of response load devices is also highly desirable for protecting privacy of private individuals, for example knowledge of operation of a given domestic device at a given private residence operable to provide responsive load service at a given time is potentially useable to mischievous parties for planning burglaries. Moreover, knowledge of individual private user's energy usage in a police state can potentially be used (in a “New World Order”) for spying and controlling individuals. The present invention seeks to avoid such incursion of private individual's privacy by applying aggregation of results describing responsive load device operation to protect the privacy of individual devices.

Optionally, the system pursuant to the present invention is implemented such that a portion of a population of power-consuming devices coupled to an electrical power network is operable to continuously communicate and/or record their availability to provide a demand response regulation to the electrical power network, for example whether or not the devices are ON or OFF, or whether they are at a mid-percentage point in respect of power consumption from the power network, and an extent to which they are available to provide and/or have provided and/or are actually providing demand response to the electrical power network. The portion of the population of devices is optionally capable of communicating their operation to a remote server or database, for example for providing data for use for controlling the electrical power network. Beneficially, BMS alarms and/or other types of messages are provided from the devices in a compressed data stream indicative of the changing availability and ON/OFF states, or transition through threshold values of availability or mid-percentage points in respect of power consumption, from which a demand response is capable of being provided by the devices. Optionally, the BMS alarms and/or other types of messages are provided in encrypted form, for example using public-private key encryption, to authenticate that a demand regulation response is genuinely being provided, for example to avoid dishonest reporting of demand load regulation being provided for which dishonest allocation of carbon credits could arise or dishonestly acquired payment for responsive load services having been provided. Optionally, when communication capacity is available to handle data traffic and sufficient computer processing power is available to handle the traffic, substantially the entire population of devices is coupled to the electrical power network and is also operable to communicate its availability to provide response regulation to the electrical power network.

In a system with power generators, an electrical power network and power consuming devices coupled via the electrical power network to the power generators, wherein the power consuming devices are designed to provide dynamic load response, a situation can arise wherein a control arrangement controlling the system has instructed one or more of the devices to function as a responsive load to try to stabilize operation of the power network, but the one or more devices have been unable to deliver the demand response desired of them. Pursuant to the present invention, the system is operable to determine an amount of service provided during an event during which demand response is request to be provided, namely called upon, and to verify whether or not demand response requested of the one or more devices has been actually provided by the one or more devices. The one or more devices can be, for example, a sample of devices in a large population of devices coupled to the electrical power network.

Optionally, the system is operable to record in a device a cumulative period, for example number of hours, during which a power consuming device has been able to provide response load service to the electricity network and a quality of such service provided. Data indicative of the cumulative number of hours is beneficially used for controlling operation of the electrical power network, for example communicated via Internet and/or by wireless; optionally, the data is provided in encrypted compressed aggregated form. Optionally, the device in which the cumulative number of hours is recorded is user accessible, for example by using data code entry via a keyboard; more optionally, the device is designed for being disposed on consumer premises and is designed to be accessible to people at the premises, for example for providing an indication of cumulative power consumed by the device during a period when it is has provided demand response to the electricity network.

The present invention is also concerned with a frequency inverter device which is operable to verify a quantity of dynamic demand response provided, for example frequency regulation response, by way of the system repeatedly sending event signals to the inverter device. Beneficially, a method of confirming an amount of dynamic demand response provided by the device can be obtained by using the repeatedly sent event signals to interrogate devices Capable of providing dynamic demand response.

When the present invention is implemented, it beneficially utilizes an in-line metering device which is operable to communicate with an appliance to measure how long the appliance is operable to provide a dynamic load response and/or dynamic frequency response for stabilizing an electrical power network coupled to supply electrical power to the appliance.

Embodiments of the invention will now be elucidated with reference to the accompanying diagrams. In FIG. 1, there is shown an industrial and commercial (I&C) measurement and validation system indicated generally by 10. The system 10 comprises one or more sample metered sites 20 coupled via a communication link 30, for example via the Internet 40, to a control arrangement 50. The control arrangement 50 comprises one-or more servers 60 for storing portfolio BMS data, for providing records of load regulation response, for example for invoicing purposes, carbon dioxide credit purchasing or payment purposes. The one or more servers 60 are coupled in communication with computing hardware 80 in a control room, namely an NGC control room for example. “NGC” is an abbreviation for National Grid Centre from which a national grid is managed.

Each sample metered site 20 comprises at least one power-consuming appliance 100, for example:
(a) a hot water system;
(b) an air conditioning system;
(c) a refrigerator;
(d) a charger for an electric and/or plug-in hybrid vehicle;
(e) a washing machine;
(f) a dishwasher;
(g) an electric oven;
(h) an electric heating, ventilation and/or cooling system for a building;
(i) a water irrigation system using electrical pumps;
(j) a water treatment works;
(k) a metal processing works;
(l) a cement works.

The power-consuming appliance is provided with power from a distribution board 110 via an electricity meter 120. The at least one power-consuming appliance 100 and the meter 120 are coupled to a data interface device 130 (for example, a proprietary “ReadM” device) whose external input/output is coupled via the communication link 30 to the one or more servers 60. The meter 120 is beneficially operable to communicate to the interface (for example “ReadM”) device 130 using a RS485/Modbus protocol. Other communication protocols are susceptible to being used for implementing the present invention.

In operation, the control arrangement 50 provides at the control room 80 a presentation as shown in FIG. 2 of dynamic demand control. Moreover, the control room 80 also enables the dynamic response provided by a population of devices to be controlled by personnel intervention and/or automatically. The system 10 is beneficially operable to provide a firm frequency response for an electrical power network coupled to the distribution board 110 with a resolution time of less than 2 seconds. Moreover, the system 10 also allows for a linear load change as a function of electrical power network alternating frequency f, for example by establishing a bidding market for devices to temporally elect periods of time in which appliances are to consume power. The system 10 is operable to compile data regarding response capabilities of the one or more sample metered sites 20. Optionally, the appliances are sold as more expensive “priority” models or less expensive “economy” models depending upon an influence that such appliances can wield in such a bidding market; in other words, an economy model seeks to consume electrical power when most economical even despite slightly inconveniencing its user, whereas a priority model seeks to use power as closely to the wishes of its user even when this means consuming power when the associated electrical power network is more heavily loaded. Other grades of model are feasible. Optionally, the appliances are user switchable between “economy mode” and “priority mode”.

The system 10 is susceptible to being adapted for use in response load service provided via refrigerator (commonly known as “fridge”) measurement and verification. A domestic premises 200 in FIG. 3 includes a refrigerator 100 coupled via a RS232 serial data connection to the interfacing (for example “ReadM”) device 130 which is further coupled via a router 210 and thereafter via the Internet 40 to the aforementioned one or more servers 60. Other devices are apt for connection to such a system for implementing the present invention.

As illustrated in FIG. 4, there is illustrated a table of aggregate load response results presented by the one or more sample metered sites 20. The aggregate load response is optionally expressed in load regulating capacity (for example in MegaWatts), instantaneous absolute power consumption (for example in MegaWatts) and/or its electrical characteristics (MegaVoltAmperes and/or Power Factor and/or MegaVoltAmperesReactive), energy stored in devices (for example as GigaJoules, or number of seconds or minutes of MegaWatt response possible remaining in the devices) and/or remaining capacity to store energy within the devices. The results are beneficially presented to personnel at the control arrangement 50 on a computer console comprising one or more display screens. The computer console beneficially also includes data entry and/or instruction entry devices, for example one or more personnel-operated keyboards.

In FIG. 5, use of the system 10 in respect of a plurality of sample metered sites 20A, 20B, 20C is illustrated. The sites 20A, 20B, 20C are optionally geographically mutually remote.

In FIG. 6, the system 10 can be employed for verifying, namely witnessing, test dynamic demand frequency response at a given site as indicated by 400. There is employed a power analyser 410 coupled to one or more appliances 100 for monitoring their power consumption characteristics in response to various conditions of electricity supply to the one or more appliances 100. Such testing and/or verification are beneficial for auditing purposes, for example in connection with issuance of carbon dioxide credits; in certain economic situations, such carbon credits are issued on a basis of operating characteristics on an appliance at its time of manufacturer, on the basis that the appliances are difficult and costly to characterize once installed at domestic customer premises.

When characterizing operation of responsive load devices, there are several different ways of parameterizing their performance, for example for use in generating aforementioned aggregated data. The present invention is also concerned with test methods for verifying that a given electrical appliance is capable of delivering dynamic load response, namely generating a model of a full extent to which a power-consuming autonomous device is capable of providing demand response to an electrical supply network to which it is operably coupled. Without such tests, an electrical power network operator must take it on trust from demand response providers that deployed products in which their technology is installed are capable of providing dynamic load response as alleged or contractually agreed upon. Such trust is an unsatisfactory guarantee when financial payments are made by the electrical power network operator to the manufacturers and/or issuance of carbon credits are involved.

Appliances which are especially suitable for provide dynamic load response include refrigerators. Refrigerators are permitted, for example by food safety standards, to maintain their internal temperatures to within a temperature range ΔT within certain upper T_{U} and lower T_{L} temperature limits as illustrated in a graph indicated by 500 in FIG. 7. In the graph 500, an abscissa axis 510 denotes a passage of time t from left to right. Moreover, an ordinate axis 520 denotes refrigerator food storage chamber temperature Tᵢ increasing from bottom to top. When a given refrigerator is permitted to allow its internal temperature Tᵢ of its food storage chamber to rise towards the upper temperature limit T_{U}, namely a regime R1, the given refrigerator will consume less power than normal from its electrical power network; such rise in temperature can be permitted until the refrigerator reaches the upper temperature T_{U}. Conversely, when the given refrigerator is permitted to allow its internal temperature Tᵢ of its food storage chamber to decrease towards the lower temperature limit T_{L}, namely a regime R2, the given refrigerator will consume more power than normal from its electrical power network; such fall in temperature can be permitted until the refrigerator reaches the lower temperature T_{L}. An amount of energy saving that is possible to achieve using the refrigerator depends upon:
(a) a thermal capacity C_{T} of the refrigerator. The thermal capacity C_{T} is a function of an amount of food and/or drink that is being stored within the refrigerator together with a heat capacity of internal structures of the refrigerator chamber; and
(b) a temperature fall which is possible to accommodate using the refrigerator, namely T_{U}-Tᵢ.

Moreover, an amount of excess energy consumption that is possible to achieve using the refrigerator depends upon:
(a) the thermal capacity C_{T} of the refrigerator; and
(b) a temperature rise which is possible to accommodate using the refrigerator, namely Tᵢ-T_{L}.

When the refrigerator is working with its temperature Tᵢ near to the upper temperature limit T_{U}, the refrigerator is capable of providing significant extra energy consumption and therefore is denoted to have a high responsive load availability (RLA) approaching 1, namely 100%, to absorb excess electrical production output. Alternatively, when the refrigerator is working with its temperature Tᵢ near to the lower temperature limit T_{L}, the refrigerator is capable of providing relatively little extra energy consumption and therefore is denoted to have a low responsive load availability (RLA) approaching 0, namely 0%, to absorb excess electrical production output.

It will be appreciated from the foregoing that momentary additional energy consumption is desirous when an electrical power network is lightly loaded and has excess power generators supplying power to the power network; the refrigerator is able to assist to provide momentary increase in energy consumption by cooling down its contents within the temperature range AT. Moreover, it will also be appreciated from the foregoing that momentary diminution in energy consumption is desirous when an electrical power network is heavily loaded and has insufficient power generators supplying power to the power network; the refrigerator is able to assist to provide momentary decrease in energy consumption by allowing its contents to warm up within the temperature range ΔT.

It will be appreciated that although the refrigerator is able to provide short-term assistance with at least partially compensating for load variations and generator variations, the refrigerator will tend towards an average temperature T_{A} over a longer period of operation; in other words, the response service provided by the refrigerators is a transient effect unless populations or devices are instructed from a central control to operate at lower temperatures on average or higher temperatures average to provide on offset effect on high-side or low-side as appropriate.

Beneficially, responsive load control of the refrigerator occurs at the refrigerator in response to a mains electricity frequency f and/or a magnitude of mains electricity V supplied thereto. The RLtec availability signal, namely responsive load availability signal (RLA), of the refrigerator is based upon its internal chamber temperature Tᵢ as aforementioned. In order for a manufacturer of refrigerators to provide proof to an electrical power network operator that the manufacturer's refrigerators are actually able to provide load response for stabilizing the power network, the manufacturer needs to undertake at least one of the following:
(a) provide proof at time of manufacture that the refrigerators are able to operate their compressors in a manner that enables the internal temperature Tᵢ on average to be varied in response to power network loading as manifest if changes in the frequency f and/or mains magnitude V;
(b) to collate data describing operation of the refrigerator during operation to show that they operate their compressors in a manner that enables the internal temperature Tᵢ on average to be varied in response to power network loading as manifest if changes in the frequency f and/or mains magnitude V; and
(c) to cause the refrigerators to change their responsive load characteristics in a manner that is discernible from measurements performed within the electrical power network.

In cases (a) and (b), it is feasible for a manufacturer of refrigerators to falsify results, such that electrical power network operators could be potentially paying for a response service which they are not subsequently receiving in practice. In case (b), encryption of data can be employed to reduce an opportunity of falsification of response results but is not totally secure. A further issue of relevance to electrical power network operators is how populations of multiple refrigerators operating in an ON/OFF and/or variable speed mode with regard to power being selectively provided to their compressors have a tendency to synchronize in the switching operations to render oscillatory variations in power network frequency f and/or voltage magnitude V worse than would occur for non-responsive loads.

The present invention seeks to address this aforementioned problem of measurement and verification of load response being provided by the refrigerators. Similar considerations pertain to other types of domestic appliance, for example air-conditioning units, heat pumps, battery chargers and so forth, employed for providing a response service pursuant to the present invention.

One method pursuant to the present invention of testing a thermal model of a refrigerator is illustrated in FIG. 8 and includes:
(i) a step 600 for extracting internal temperatures Tᵢ and compressor states, namely whether the compressor is ON or OFF as a function of time t, for a plurality of refrigerator coolers over a plurality of periods of fridge duty cycle at a constant nominal network frequency f for example, extracting results for a plurality of refrigerators over a period of several duty cycles at a nominal mains frequency, for example f=50.000 Hz; optionally, this step 600 is implemented in respect of any signal sent to a refrigerator (for example frequency and/or any other electricity grid signal (EGS) indicating in operation that demand response is required;
(ii) a step 610 for collating data from (i) and analysing the data for determining whether or not ON/OFF duty cycle lengths and ON/OFF duty cycle ratios are susceptible to being regarding as characteristic for the two refrigerators;
(iii) a step 620 for selecting a representative duty cycle for one or more refrigerators in step (i) in an event that ON/OFF duty cycles in step (ii) are representative of the one or more refrigerators;
(iv) a step 630 for comparing, for example visually and/or by data analysis tools, a span of a plurality of modelled switching data for the plurality of refrigerators against sampled ON/OFF switching data for the plurality of refrigerators; for example, by comparing a span of 4 to 5 duty cycles of modelled data against real-time sampled data from two refrigerators; and
(v) a step 640 calculating least-squares errors, or similar error indication, between the modelled and measured results for the plurality of refrigerators to ensure a satisfactory goodness of fit.

The electrical power network operators are desirous to⁻have refrigerators spatially distributed amongst users and coupled up to the electrical power network for providing response load stabilization in a spatially distributed manner, wherein the refrigerators are providing a useful response; matching of modelled results necessary for providing a response with measured ON/OFF switching data representative of suitable response provides confirmation that the refrigerators are susceptible to providing network load response.

A more detailed version of the test denoted by steps (i) to (v) above involves determining the following one or more parameters for characterizing the plurality of refrigerators:
(a) a variable T;
(b) a variable η;
(c) a variable α; and
(d) a variable β.

Referring to FIG. 9, there is shown a graph indicated generally by 700 illustrating load availability (RLA) represented along an ordinate axis 720 as a function of time t represented along an abscissa axis 710.

Variable α is defined as:

α=a proportion of time available to switch ON; or

α=a time available to switch ON/(time ON+time OFF).

Variable β is defined as:

β=a proportion of time available to switch OFF; or

β=a time available to switch OFF/(time ON+time OFF).

In FIG. 10, there is illustrated a linear representation of ON/OFF switching of a refrigerator-type device in a graph indicated generally by 800. The graph 800 includes an abscissa axis 810 denoting increasing time t from left to right, and an ordinate axis 820 denoting load availability (RLA) from 0% to 100% from bottom to top respectively. T_{ON} denotes a time period when a compressor of the refrigerator is energized, and T_{OFF} denotes a time period during which the compressor is not energized. When considering the refrigerator, or for that matter any electrical load device with an ON/OFF switching characteristic, it is feasible to derive a maximum response capacity (RCAP) for the refrigerator which can be further described in terms of high-side and low-side response RCAP_{HIGH} and RCAP_{LOW}. If the refrigerator has an average load rating of ×Watts, the expected maximum response available from the refrigerator is:

RCAP_{HIGH}=α×(Watts); and (a)

RCAP_{LOW}=β×(Watts). (b)

Linear interpolation can be used to determine, for example, a linear response provided by the refrigerator as a function of mains frequency deviations Δf from a nominal frequency f₀ towards upper and lower frequency limits fᵤ and f, for example f₀=50.0 Hz, fᵤ=50.5 Hz and fₗ=49.5 Hz, in a situation where the refrigerator provides high-side and low-side response:

RCAP(Δf)=α×Δf/(fᵤ−f₀) for Δf>0 Hz; and (i)

RCAP(Δf)=α×Δf/(f₀−fₗ) for Δf<0 Hz. (ii)

When there are N refrigerators in a population of refrigerators, a degree of response is magnified by a factor of N for the population.

The aforementioned variable T is representative of a complete cycle time for the refrigerator as illustrated in FIG. 10. Beneficially, the variable T is found by measurement or determined from designs of the refrigerator, namely a fullest extent of possible response is determined. In practice, the variable T will be varying depending on contents of the refrigerator being varied from time to time by users. The parameter η is a working ratio of the compressor of the refrigerator, namely how effective the compressor of the refrigerator is at removing heat energy from an interior chamber of the refrigerator; the work ratio η will depend upon a type of compressor utilized and its associated effectiveness.

When values for variables α, β, η and T have been obtained, the refrigerator has been then effectively characterized for purposes of verification of response load performance that can be provided, namely fullest extent response. In an event that the refrigerator has been designed to provide asymmetrical low-side and high-side response, the refrigerator is beneficially characterized by measuring its performance for a few cycles when presented with various mains frequencies f between upper and lower frequency limits fᵤ and fₗ respectively.

Beneficially, individual refrigerators are tested in isolation, and then tested in groups to determine whether or nor mutual interaction occurs, for example whether or not any tendency to synchronize is evident.

Beneficially, when characterizing the refrigerators for generating a parameterized model, one or more of the following tests are performed:
(a) a thermal model calibration is performed at nominal mains frequency f₀;
(b) a damped frequency test is performed to determine how rapidly one or more of the refrigerators respond to a frequency perturbation applied to the one or more refrigerators;
(c) a test is performed to determine a nominal frequency f₀ adopted by the refrigerator when in operation;
(d) a test is performed to determine an upper and lower frequency limit for mains supply provided to the refrigerator to check for conformity with specifications;
(e) trigger frequencies for the refrigerators are determined for a nominal centre frequency f₀, for example 50.0 Hz (tarF test); and
(f) a staggered response and/or aggregate response for one or more refrigerators are determined.

These measurements are beneficially executed under test conditions in a factory or laboratory in contradistinction to measuring devices already operable and connected to an electricity supply network. Thereby, it is possible to determine a fullest potential extent to which devices operable pursuant to the present invention are able to respond when providing a responsive load service.

A manufacturer and/or an electrical power network operator and/or demand response aggregator beneficially use tests as described in the forgoing for checking refrigerators, or other types of ON/OFF appliances, to ensure compliance for providing dynamic load response for stabilizing an electrical power network. Such tests are beneficially undertaken at manufacturer, but can also optionally be applied after installation of the appliances has occurred or at other points in a supply chain, during distribution or a point of sale, or as a result or random sampling of the products. Moreover, during operation in conjunction with aforementioned interface (for example, proprietary “ReadM”) devices 130 for monitoring operation of the refrigerator, the refrigerator and its associated interface device 130 can generate in operation one or more of the variables T, η, α, b, RLA as a function of time, as well as temperature Tᵢ within the refrigerator as a function of time t. Such parameters are beneficially communicated from the refrigerator via the interface(for example proprietary “ReadM” device) device to the one or more server 60, for example in an encrypted and/or aggregate data streams, for verification purposes regarding device operation and response service provided in operation.

As aforementioned, although an example of a refrigerator with its compressor operating in an ON/OFF manner is used in the foregoing to provide an example of an embodiment of the present invention providing response service, it will be appreciated that the invention is capable of being employed with other types of power-consuming devices, preferably, but not solely, operating in an ON/OFF manner, for providing response service to an electrical power network.

Although the present invention is described in the foregoing in respect of parameterized representation of refrigerators as power consuming devices, the present invention is also susceptible to being used with other types of power consuming devices. For example, the power consuming device is a battery of heating elements provided with thyristor power control. The battery has a maximum heating power of 30 kW but under usual operating conditions is typically consuming in a range of 5 kW to 10 kW. Merely monitoring operation of the battery as a “black box” using measurements would indicate that the battery has an observed maximum load magnitude of 10 kW. However, pursuant to the present invention, the battery would be analyzed and its 30 kW heating capacity determined, together with its thermal time response. Such analysis would identify, amongst other issues, that the battery can be used to provide an instantaneous 30 kW load for short instances of duration less than the thermal response (i.e. thermal time constant) without greatly affecting an average output temperature affected by power dissipated within the battery. An approach pursuant to the present invention would enable the battery to provide a greater degree of responsive load service, than would be possible if the battery were characterized in a conventional “black box” approach.

A yet alternative example concerns a hot water tank equipped with multiple heaters H1, H2, H3 which are individually susceptible to being energized for heating water in the water tank. In normal operation, it is found that only one of the heaters H1 is employed for heating water within the water tank, such that a measured “black box”; measurements performed on the hot water tank would only identify existence of the heater H1. Analysis performed pursuant to the present invention would identify existence of all the heaters H1, H2, H3, and a control algorithm for providing demand response by way of the heaters H1, H2, H3 would provide a greater degree of short-term peak load in comparison to a convention approach which would only identify existence of the heater H1. The existence of the heaters H1, H2, H3 and their respective power consumption P1, P2, P3 respectively and thermal response time constants τ₁, τ₂, τ₃ would be parameters which are beneficially utilized for devising an optimal algorithm for providing response demand service to electrical power distribution network, namely an electrical grid.

Other examples of power consuming devices which would also benefit form the present invention include an air handling unit including a heating element, a variable speed fan and one or more dampers; methods pursuant to the present invention would identify the individual components present in the air handling unit and their associated parameters, whereas a convention “black box” approach would potentially be unrepresentative and result in a suboptimal demand response algorithm being developed.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A method of determining a level of potential responsive-load electrical power network service susceptible to being provided by one or more power consuming devices, wherein said method includes:
(a) determining operating characteristics of one or more power consuming devices;
(b) developing a model of operation of the one or more power consuming devices based upon the determined operating characteristics; and
(c) developing an operating regime using the model of operation and a set of operating rules for the one or more devices for providing responsive-load electrical power network service, wherein
the model of operation of the one or more power consuming devices is a parameterized numerical model; and
the determined operating characteristics includes a maximum load capacity of the one or more power consuming devices potentially available for the responsive-load electrical power network service.

2. A method as claimed in claim 1, wherein the one or more devices are operably functional to provide the responsive-load electrical power network service in an autonomous manner.

3. A method as claimed in claim 1, including:
(d) applying the operating regime to the one or more devices for providing the responsive-load electrical power network service.

4. A method as claimed in claim 1, wherein the parameterized numerical model of operation describes a fullest extent to which the one or more power consuming devices are capable of providing the responsive-load electrical power network service.

5. A method as claimed in claim 1, further including monitoring operating characteristics of the one or more power consuming devices after installation for verifying their responsive-load electrical power network service.

6. A method as claimed in claim 5, wherein monitoring of the one or more devices is performed remotely via one or more interface devices.

7. A method as claimed in claim 1, wherein said determination of said operating characteristics includes determining at least one of parameters α, β, η and T, wherein the parameters α and β describe an expected proportion of time in which the one or more devices are able to switch ON/OFF, the parameter η describes a working ratio of the one or more devices, and the parameter T describes operating cycle times of the one or more devices.

8. A method as claimed in claim 3, wherein said method includes at least one of:
(a) communicating an availability of the one or more power consuming devices to provide a responsive-load electrical power network service;
(b) communicating an amount of stored energy in said one or more power consuming devices;
(c) communicating an amount of energy storage capacity remaining in said one or more power consuming devices and/or the amount actually consumed;
(d) communicating an indication of a power load and/or aggregate load response said one or more power consuming devices are capable of providing and/or are actually providing to the electrical power network; and
(e) communicating an indication of the absolute power load said one or more power consuming devices are actually in operation consuming from the electrical power network.

9. (canceled)

10. (canceled)

11. A system for monitoring and determining a level of a responsive-load electrical power network service to be provided by one or more power consuming devices coupled via an electrical power network to one or more power generators, said electrical power network service including at least one of: frequency control and load control, the system including:
an interface device, adapted for communication with the one or more power consuming devices or an electricity meter (M); and
a data processing device communicatively coupled with the interface device, the data processing device being adapted to:
(i) develop a parameterized numerical model of operation of the one or more power consuming devices based upon determined operating characteristics of the one or more power consuming devices, one of the determined operating characteristics being maximum load capacity of the one or more devices potentially available for the responsive-load electrical power network service; and
(ii) develop an operating regime using the numerical model and a set of operating rules for the one or more devices for providing a responsive-load electrical power network service.

12. A responsive-load electrical power service control system for controlling a level of a responsive-load electrical power network service to be provided by one or more power consuming devices according to the method of claim 3, the one or more power consuming devices being coupled via an electrical power network to one or more power generators, said electrical power network service including at least one of: frequency control and load control, said responsive-load electrical power service control system including:
an interface device adapted for communication with the one or more power consuming devices; and
a data processing device communicatively coupled with the interface device, the control system being adapted to communicate at least one of the following variables:
(a) an availability of the one or more power consuming devices to provide load response service;
(b) an amount of stored energy in said one or more power consuming devices;
(c) an amount of energy storage capacity remaining in said one or more power consuming devices and/or the amount actually consumed;
(d) an indication of a power load and/or aggregate load response said one or more power consuming devices are capable of providing and/or are actually providing to the electrical power network; and
(e) an indication of the absolute power load said one or more power consuming devices are actually consuming from the electrical power network.

13. The control system as claimed in claim 12, further comprising a power scheduler adapted to utilize information on the at least one variable to schedule a configuration of the one or more power generators.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A control system as claimed in claim 12, wherein the system is operable to determine an amount of responsive-load electrical power network service provided during an event when the service is invoked, wherein provision of the service is verified by comparing an actual electrical consumption of a sample of devices with an estimated consumption of those devices and/or an estimated consumption of devices in a population.

27. (canceled)

28. (canceled)

29. (canceled)

30. (canceled)

31. (canceled)

32. (canceled)

33. (canceled)

34. (canceled)

35. A control system as claimed in claim 12, wherein the interface device is operable to control provision of the responsive-load electrical power network service by the one or more power consuming devices in response to a remotely transmitted signal.

36. A method as claimed in claim 3, including:
(e) recording a cumulative period during which the one or more devices were able to provide the responsive-load electrical power service and a quality of the service provided.

37. A method as claimed in claim 1, including providing the responsive-load electrical power network service in response to a remotely transmitted signal.
